(19) United States
(12) Patent Application Publication
(10) Pub. No.: US 2018/0133920 A1
(43) Pub. Date: May 17, 2018

(54) HOLLOW BAMBOO STRIP, HOLLOW BAMBOO BOARD AND MANUFACTURING METHOD THEREOF

(71) Applicant: Fujian Shuangyi Bamboo and Wood Development Co., Ltd, Nanping (CN)

(72) Inventor: ZHISHENG LI, NANPING (CN)

(21) Appl. No.: 15/693,185

(22) Filed: Aug. 31, 2017

(30) Foreign Application Priority Data
Nov. 17, 2016 (CN) 201611012104.X

(51) Int. Cl. B27J 1/00; B27K 9/00

(52) U.S. Cl. CPC B27J 1/003; B27K 9/002

(57) ABSTRACT

A hollow bamboo strip includes mao bamboo sheets formed by splitting bamboo; the two sides of a mao bamboo sheet are cut with matching surfaces, thereby making a finished bamboo sheet with a trapezoidal cross section, the matching surfaces of a plurality of finished bamboo sheets are successively spliced or finger jointed into a hollow bamboo strip with a hollow structure. A hollow bamboo board is spliced by fitting several hollow bamboo strips at side surfaces. A method for manufacturing a hollow bamboo board includes: splitting the bamboo into several mao bamboo sheets in its peripheral direction; cutting a mao bamboo sheet into a finished bamboo sheet with a trapezoidal cross section; carbonizing the finished bamboo sheet; forming the finished bamboo sheets subjected to carbonization into a hollow bamboo strip; fitting corresponding side surfaces of several hollow bamboo strips to be spliced into a hollow bamboo board.

### CROSS-REFERENCE TO RELATED APPLICATIONS

This application claims priority to Chinese Patent Application No. 201611012104.X with a filing date of Nov. 17, 2016. The content of the aforementioned applications, including any intervening amendments thereto, are incorporated herein by reference.

### TECHNICAL FIELD

The present invention relates to the field of a bamboo product, and in particular, to a hollow bamboo strip, a hollow bamboo board and a manufacturing method thereof.

### BACKGROUND OF THE PRESENT INVENTION

The bamboo product is mainly made of high-quality mao bamboo and dendrocalamus latiflorus, which not only has the advantages of difficult deformation, difficult cracking, high intensity, corrosion resistance, absorption of moisture and heat, and UV and harmful gas absorption, but also has the property of environmental protection, thereby being well received by consumers.

A bamboo board is usually formed by laminating processed bamboo strips via certain processes. Currently, the bamboo board commonly has a solid structure, which not only causes material waste, but also tends to be deformed due to its stress. Meanwhile, in an initial production stage, fresh mao bamboo or dendrocalamus latiflorus is split into mao bamboo sheets 1 as shown in FIG. 1, and then is processed into a bamboo strip with a rectangular parallelepiped cross section, which causes more loss in raw materials due to much waste to be cut out.

### SUMMARY OF PRESENT INVENTION

In order to solve the above problem, the present invention provides a hollow bamboo strip, a hollow bamboo board and a manufacturing method thereof, capable of reducing losses of raw materials while keeping mechanical properties of the hollow bamboo strip and the hollow bamboo board unchanged substantially, such that the raw material is taken full advantage.

A hollow bamboo strip according to the present invention includes mao bamboo sheets formed by splitting bamboo. The two sides of a mao bamboo sheet are cut with matching surfaces, thereby making a finished bamboo sheet with a trapezoidal cross section. The matching surfaces of a plurality of finished bamboo sheets are successively spliced or finger jointed into a hollow bamboo strip with a hollow structure.

Further, a cross section of the hollow bamboo strip is an equilateral polygon. For example, its cross section is a square or a regular hexagon.

Further, the hollow bamboo strip is filled with one or more of a thermal insulation material, a sound-proof material or a fire-proof material therein, so as to improve its overall performance.

A hollow bamboo board is spliced by fitting the above hollow bamboo strips at side surfaces.

A method for manufacturing a hollow bamboo board, including:

(1) splitting the bamboo into several mao bamboo sheets in its peripheral direction;

(2) cutting a mao bamboo sheet into a finished bamboo sheet with a trapezoidal cross section;

(3) carbonizing the finished bamboo sheet;

(4) forming the finished bamboo sheets subjected to carbonization into a hollow bamboo strip;

(5) fitting corresponding side surfaces of several hollow bamboo strips to be spliced into a hollow bamboo board.

Further, the trapezoidal structure in the step 2 is an isosceles trapezoid with a bottom angle ranging from 40° to 70°.

The hollow bamboo strip according to the present invention is a product specially designed on the basis of the structure of mao bamboo or dendrocalamus latiflorus, with less waste to be cut out during production and processing, which saves a large amount of raw materials, has a property of stress buffer due to its unique hollow structure, and does not tend to be deformed.

The hollow bamboo board according to the present invention consists of the above hollow bamboo strips. Compared with the existing solid bamboo board, with the same thickness, the present invention uses fewer raw materials, and does not tend to be deformed.

In the method for manufacturing a hollow bamboo board according to the present invention, less waste is cut out during processing, the raw material is saved up to the greatest degree, and the hollow bamboo board produced by this method has the advantages of material saving and difficult deformation.

### DESCRIPTION OF THE DRAWINGS

FIG. 1 is a structural schematic diagram of a bamboo sheet formed by splitting mao bamboo or dendrocalamus latiflorus.

FIG. 2 is a structural schematic diagram of a cross section of a finished bamboo sheet according to the present invention.

FIG. 3 is a structural schematic diagram of a hollow bamboo strip with a square cross section according to the present invention.

FIG. 4 is a structural schematic diagram of a cross section in FIG. 3.

FIG. 5 is a structural schematic diagram of a hollow bamboo board according to one embodiment of the present invention.

FIG. 6 is a structural schematic diagram of a hollow bamboo board according to another embodiment of the present invention.

### DETAILED DESCRIPTION OF PREFERRED EMBODIMENTS

In order to better set forth the present invention, the present invention will be explained below in detail in combination with the embodiments.

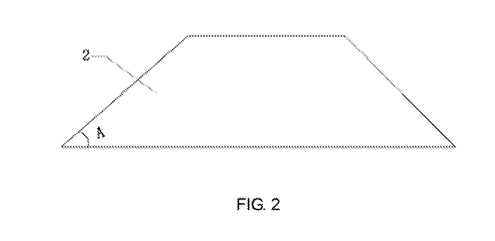

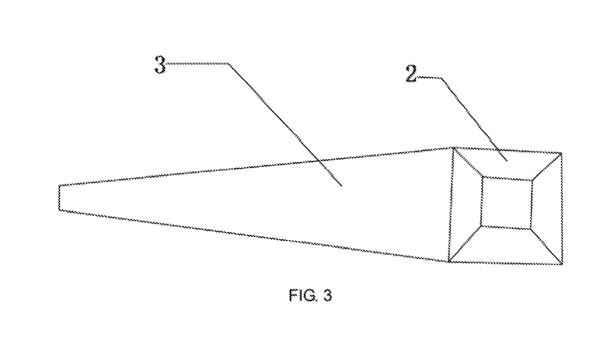

As shown in FIGS. 2-4, a hollow bamboo strip 3 consists of a plurality of finished bamboo sheets 2 with a trapezoidal cross section and a hollow structure. Such a structure has the advantage of material saving, and avoids the deformation of the hollow bamboo strips 2 due to its property of stress buffer.

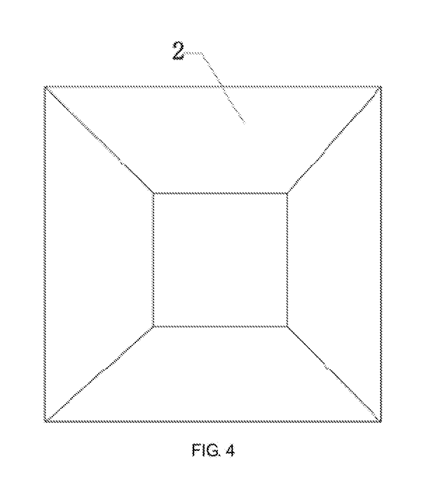

Specifically, the cross section of the hollow bamboo strip 3 is a square (as shown in FIG. 4) or a regular hexagon. Such a structure may reserve the raw material to the greatest degree, has less waste of the bamboo sheet to be cut out, and is convenient to splice and combine the products subsequently.

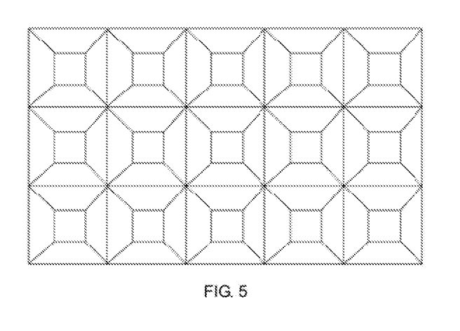

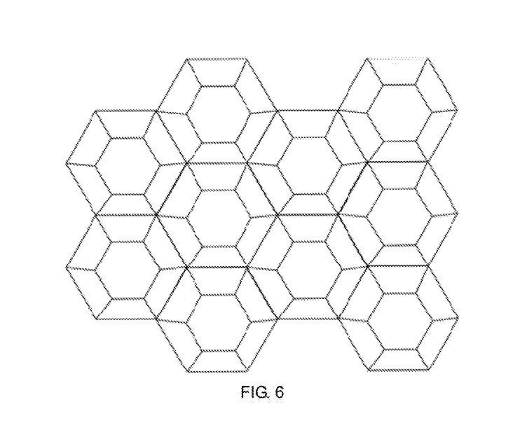

As shown in FIGS. 5-6, a hollow bamboo board is formed by splicing the hollow bamboo strips 3 at side surfaces. Similarly, such a hollow bamboo board saves materials, has the characteristic of stress buffer and is not easily deformed.

Further, in other embodiments, the hollow bamboo strip 3 is filled with one or more of a thermal insulation material, a sound-proof material or a fire-proof material therein, so as to improve its overall performance.

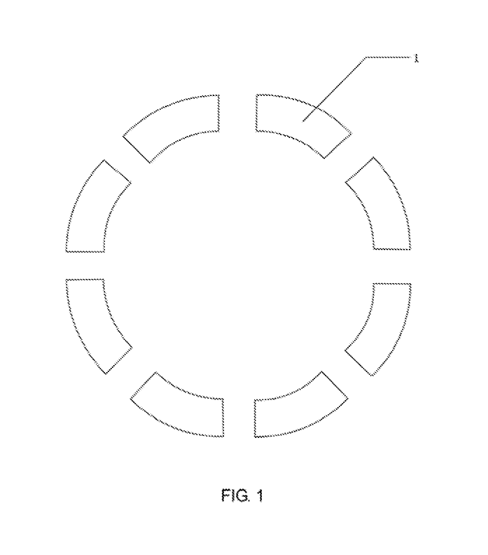

As shown in FIGS. 1-6, a method for manufacturing a hollow bamboo board includes:

(1) splitting fresh bamboo into several mao bamboo sheets 1;

(2) cutting a mao bamboo sheet 1 into a finished bamboo sheet 2 with an isosceles trapezoidal cross section, with a bottom angle ranging from 40° to 70°;

(3) carbonizing the finished bamboo sheet 2;

(4) subsequent to carbonization, forming the finished bamboo sheets 2 into a hollow bamboo strip 3;

(5) fitting side surfaces of the above hollow bamboo strips 3 to be spliced into a hollow bamboo board.

It is known from geometric knowledge that such a processing method can reserve the raw materials to the greatest extent, and reduce the waste to be cut out. Compared with the existing bamboo sheet with a rectangular cross section, its waste is much less, with considerable economic benefits for an enterprise with an output value of tens of millions.

The above embodiments are not taken as further limits to the present invention. Non-material modifications to the contents of the present invention made by persons skilled in the art shall fall within the protection scope of the present invention.

I claim:

1. A hollow bamboo strip, comprising mao bamboo sheets formed by splitting bamboo; the two sides of a mao bamboo sheet are cut with matching surfaces, thereby making a finished bamboo sheet with a trapezoidal cross section, the matching surfaces of a plurality of finished bamboo sheets are successively spliced or finger jointed into a hollow bamboo strip with a hollow structure.

2. The hollow bamboo strip according to claim 1, wherein a cross section of the hollow bamboo strip is an equilateral polygon.

3. The hollow bamboo strip according to claim 2, wherein the hollow bamboo strip is filled with one or more of a thermal insulation material, a sound-proof material or a fire-proof material therein.

4. A hollow bamboo board, spliced by fitting the hollow bamboo strips according to claim 1 at side surfaces.

5. A method for manufacturing a hollow bamboo board, comprising:
(1) splitting the bamboo into several mao bamboo sheets in its peripheral direction;
(2) cutting a mao bamboo sheet into a finished bamboo sheet with a trapezoidal cross section;
(3) carbonizing the finished bamboo sheet;
(4) forming the finished bamboo sheets subjected to carbonization into a hollow bamboo strip;
(5) fitting corresponding side surfaces of several hollow bamboo strips to be spliced into a hollow bamboo board.

6. The hollow bamboo board according to claim 5, wherein the trapezoidal structure in the step 2 is an isosceles trapezoid with a bottom angle ranging from 40° to 70°.
